(19) United States
(12) Patent Application Publication
(10) Pub. No.: US 2026/0197874 A1
(43) Pub. Date: Jul. 9, 2026

(54) METHOD AND APPARATUS FOR PHASE OFFSET ESTIMATION AND COMPENSATION FOR PRACH WITH LARGE FREQUENCY OFFSET

(71) Applicant: HONG KONG APPLIED SCIENCE AND TECHNOLOGY RESEARCH INSTITUTE COMPANY LIMITED, Shatin (HK)

(72) Inventors: Yaming Luo, Kowloon (HK); Tingting Wei, Shenzhen (CN); Yuxian Zhang, Tai Po (HK); Eddy Chiu, Kowloon (HK)

(21) Appl. No.: 19/013,436

(22) Filed: Jan. 8, 2025

(51) Int. Cl. H04W 74/0833; H04L 1/18; H04L 5/00

(52) U.S. Cl. CPC H04W 74/0833; H04L 1/18; H04L 5/0048

(57) ABSTRACT

The embodiments herein relate to method and apparatus for phase offset estimation and compensation for Physical Random Access Channel (PRACH) with large frequency offset. In some embodiments, there proposes a method for Physical Random Access Channel (PRACH) preamble detection. The method may comprise the steps of receiving a PRACH preamble with a plurality of repeated sequences, in which each sequence includes a plurality of elements on a plurality of antennas; performing a phase offset estimation for multiple repetitions within the plurality of repeated sequences, by selectively correlating the multiple repetitions based on magnitudes of the elements; performing a phase compensation for the multiple repetitions, based on the estimated phase offset; performing a sequence combination for the multiple repetitions; and performing a sequence detection on the combined multiple repetitions.

### TECHNICAL FIELD

The embodiments herein relate generally to the field of communication, and more particularly, the embodiments herein relate to method and apparatus for phase offset estimation and compensation for Physical Random Access Channel (PRACH) with large frequency offset.

### BACKGROUND

PRACH preamble is a special sequence used in wireless communication systems for synchronizing and identifying. In Long Term Evolution (LTE) and 5th Generation Mobile Communication Technology (5G) systems, the PRACH preamble plays an important role in the random access process.

PRACH preamble normally has multiple repeated sequences, so as to improve the coverage and anti-interference capability and to support beam sweeping. For example, in format B4 (short sequence), there are 12 repeated sequences, and in format 3 (long sequence), there are 4 repeated sequences. For example, a Zadoff-Chu (ZC) sequence with the symbol length of 139, 839, 569, or 1149 may be used as a PRACH sequence.

FIG. 1 shows an example decoding method 100 for PRACH preamble. The signal may be received on multiple antennas, and the received signal on each antenna may include multiple sequences for example 12 sequences, each sequence may include multiple symbols. In the example method 100 of FIG. 1, downsampling step 110, serial-to-parallel conversion step 120, correlation step 130, signal combination step 140 may be performed on the received signal in this order. Signal combination step 140 may include sequence combination and antenna combination. Then, detection step 150 may be performed on the combined sequences, by compared with the local sequence(s) to determine the matched sequence.

That is, in the method 100 of FIG. 1, the sequences in the received signal are correlated at step 130 and then combined at step 140. Since the received signal has multiple sequences (for example 12 sequences), it is not complex and will cause huge complexity, no matter performed in time or frequency domain, for correlating all the 12 sequences. Thus, an improved approach is performing the sequence combining before correlation, as shown in FIG. 2.

FIG. 2 shows another example decoding method 200 for PRACH preamble. In FIG. 2, compared with FIG. 1, there is an additional sequence combination step 225 between the serial-to-parallel conversion step 120 and the correlation step 130. In step 225, for example all 12 sequences may be combined as one sequence, so that the complexity at the correlation step 130 may be reduced. Then, in step 240, the antenna combination may be performed. The method 200 in FIG. 2 may improve the PRACH preamble decoding and detection by reducing the complexity. However, there still may be some problem.

In a Non-Terrestrial Network (NTN), the mismatch of Carrier Frequency Offset (CFO) between transmitter and receiver may larger than the terrestrial network, due to high mobility. For example, in an NTN network relayed by satellite (or be referred as satellite network), due to the high mobility of satellites (especially Low Earth Orbit satellite), the Doppler frequency shifting will cause the mismatch of CFO between transmitter and receiver. Similar problem may exist for the mobile network related to the High-speed train (HST), which is considered as one of the essential verticals in 5G applications, very large CFO exists due to the rapid moving of the train as well as the mobile devices on the train. Prior information about the satellite orbits or train cannot efficiently mitigate the influence of CFO, and there still exist non-negligible residual CFO after CFO pre-compensation.

At the transmitter side, the sequences originally convey same signal, but if large CFO exists, at the receiver side, different sequences will have different phase offsets. FIG. 3 shows the phase offsets of different sequences of the received signal. For example, as shown in FIG. 3, the first sequence (sequence 0) may be considered to be phase aligned, but the following sequences may have phase offsets caused by the CFO. The phase offset may be accumulated on time, that is each symbol may have larger phase offset than the previous symbol. The slope of the phase offsets may be the CFO. That is, sequence 1 may have the phase offset of ΔΦ, sequence 2 may have the phase offset of 2ΔΦ, and so on. The phase offset may be harmful on the sequence combination introduced in step 225 of FIG. 2, since the sequences or symbols will cancel each other, if the phase offset between them is 180 degrees (or π). As a result, the detection performance may be poor.

The patent publication CN108040366A proposes a random access preamble signal detection method based on frequency offset correction. The method comprises the steps of: calculating available time-frequency resources, generating 64 preamble sequences, and randomly selecting a preamble sequence as a sending preamble sequence; finding out a sub-frame, which is a PRACH time-domain sub-frame currently; according to related parameters, estimating a Doppler frequency offset value through a maximum likelihood (ML) criterion as frequency offset compensation; performing cyclic prefix elimination, down-sampling filtering and Fourier transformation on processed signals; performing frequency domain correlation of the preamble sequences and local ZC root sequences; and, performing inverse fast Fourier transformation, modular square and multi-antenna combination on frequency domain correlation sequences, calculating a power delay spectrum energy (PDP), and comparing the power delay spectrum energy (PDP) with detection thresholds A and B, so that a preamble serial number ID and the time advance (TA) are obtained. However, the CFO before downsampling approach in CN108040366A may be directly processing the undownsampled signal is more difficult to implement, and storing the undownsampled signal will increase saving overhead. Problems particularly for CN108040366A may be that it assumes known time offset and it depends on the accuracy of the Signal Noise Ratio (SNR) estimation.

The patent publication CN112887241A proposes a frequency offset estimation method and device, a communication device and a storage medium, the method comprising: when it is detected that there is an access signal in a PRACH signal sent by a signal sending end, obtaining a main peak and an auxiliary peak of the PRACH signal, the PRACH signal being composed of a preset number of identical pilot sequences; determining a first frequency offset according to the peak value of the main peak and the peak value of the secondary peak; performing frequency offset compensation on the PRACH signal according to the first frequency offset to obtain a compensation sequence after frequency offset compensation; and calculating a frequency offset between the compensation sequence and the pilot sequence to obtain a second frequency offset, and performing time delay estimation on the access signal according to the second frequency offset. The patent publications U.S. Pat. No. 9,491,024B2, WO2010040264A1, WO2013172748A1 (US20150139098A1) propose CFO after correlation approach similar to the CN112887241A. However, the CFO after correlation approach in CN112887241A cannot be used for the considered scenario in which the phase offset is estimated before correlation, but the peaks can only be obtained after the correlation. Problems particularly for CN112887241A may be that: PRACH format is modified, thus not suitable for PRACH format specified by 3rd Generation Partnership Project (3GPP) and it may have high complexity.

### SUMMARY

As seen, for PRACH reception in large CFO cases, if combining sequence after correlation (FIG. 1), there may be huge complexity; and if combining sequence before correlation (FIG. 2), there may be poor detection performance. Thus, it is an objective to propose a new algorithm with CFO estimation/compensation before the early combination, and has good balance of complexity and detection performance.

In view of the above, the embodiments herein propose method and apparatus for phase offset estimation and compensation for Physical Random Access Channel (PRACH) with large frequency offset.

In some embodiments, there proposes a method for PRACH preamble detection. The method may comprise at least the steps of receiving a PRACH preamble with a plurality of repeated sequences, in which each sequence includes a plurality of elements on a plurality of antennas; performing a phase offset estimation for multiple repetitions within the plurality of repeated sequences, by selectively correlating the multiple repetitions based on magnitudes of the elements; performing a phase compensation for the multiple repetitions, based on the estimated phase offset; performing a sequence combination for the multiple repetitions; and performing a sequence detection on the combined multiple repetitions.

In some embodiments, there proposes a PRACH receiver in a wireless communication system, the PRACH receiver may comprise a memory storing machine-readable instructions; and a processor for executing the machine-readable instructions. When the processor executes the machine-readable instructions, it configures the PRACH receiver to: receive a PRACH preamble with a plurality of repeated sequences, in which each sequence includes a plurality of elements on a plurality of antennas; perform a phase offset estimation for multiple repetitions within the plurality of repeated sequences, by selectively correlating the multiple repetitions based on magnitudes of the elements; perform a phase compensation for the multiple repetitions, based on the estimated phase offset; perform a sequence combination for the multiple repetitions; and perform a sequence detection on the combined multiple repetitions.

In some embodiments, there proposes a computer readable product comprising computer readable code, which when run on an apparatus, causes the apparatus to perform the above method.

The embodiments may propose a new algorithm with CFO estimation/compensation before the early combination, and has good balance of complexity and detection performances. For example, the embodiments may have low missed detection rate (MDR), MDR means that the PRACH is transmitted, but not detected (i.e., missing detection); the embodiments may also have low false alarm rate (FAR), FAR means that no PRACH is transmitted, but receiver falsely detects a PRACH (i.e., false alarm).

### BRIEF DESCRIPTION OF THE DRAWINGS

The accompanying drawings, which are incorporated herein and form part of the specification, illustrate various embodiments of the present disclosure and, together with the description, further serve to explain the principles of the disclosure and to enable a person skilled in the pertinent art to make and use the embodiments disclosed herein. In the drawings, like reference numbers indicate identical or functionally similar elements, and in which:

FIG. 1 shows an example decoding method for PRACH preamble;

FIG. 2 shows another example decoding method for PRACH preamble;

FIG. 3 shows the phase offsets of different sequences of the received signal;

FIG. 4 shows an example decoding method for PRACH preamble, according to the embodiments herein;

FIG. 5 shows the magnitude variation in the undownsampled signal;

FIG. 6 shows an example phase offset estimation approach, according to the embodiments herein;

FIG. 7 shows an example phase offset compensation approach, according to the embodiments herein;

FIG. 8 shows an example PRACH receiver, according to the embodiments herein; and

FIG. 9 shows an example computer-implemented apparatus, according to the embodiments herein.

### DETAILED DESCRIPTION OF EMBODIMENTS

Embodiments herein will be described in detail hereinafter with reference to the accompanying drawings, in which embodiments are shown. These embodiments herein may, however, be embodied in many different forms and should not be construed as being limited to the embodiments set forth herein. The elements of the drawings are not necessarily to scale relative to each other.

Reference to “one embodiment” or “an embodiment” means that a particular feature, structure or characteristic described in connection with the embodiment is included in at least one embodiment. Thus, the appearances of the phrase “in an embodiment” appearing in various places throughout the specification are not necessarily all referring to the same embodiment.

As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. As used throughout this description, and in the claims, a list of items joined by the term “at least one of” or “one or more of′ can mean any combination of the listed terms. For example, the phrase “at least one of A, B or C” can mean A; B; C; A and B; A and C; B and C; or A, B and C.

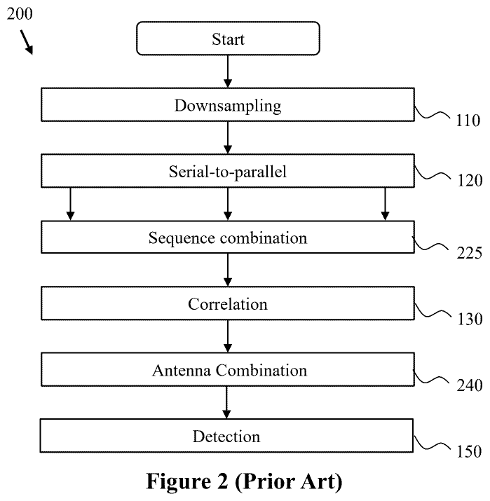

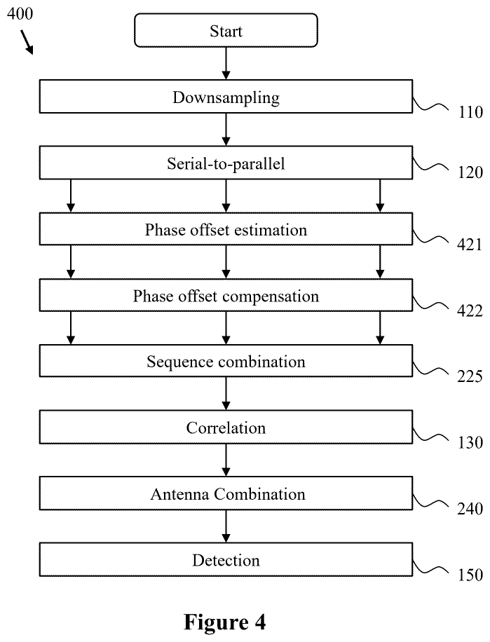

FIG. 4 shows an example decoding method for PRACH preamble, according to the embodiments herein. In FIG. 4, compared with FIG. 2, the method 400 may further comprise a phase offset estimation step 421 and a phase offset compensation step 422. Note that, the phase offset estimation step 421 and a phase offset compensation step 422 may be combined into a single phase offset estimation and compensation step.

In the example method 400 of FIG. 4, downsampling step 110, serial-to-parallel conversion step 120, the phase offset estimation step 421, a phase offset compensation step 422, sequence combination step 225, correlation step 130, antenna combination step 240, and a detection step 150 may be performed on the received signal in this order.

In an example, the method is implemented on a Non-Terrestrial Network (NTN) PRACH receiver, such as receiver of high-speed railway or satellite-based system.

In an example, before the phase offset estimation step 421 and the phase offset compensation step 422, there may be a pre-compensation step, in which the sequences (i.e., repetitions) may be pre-compensated in advance, based on satellite orbit information. Then the remaining (or residual) phase offset may be estimated and compensated at the phase offset estimation step 421 and the phase offset compensation step 422 respectively.

The PRACH preamble signal may be received on multiple antennas, and the received signal on each antenna may include multiple sequences for example 12 sequences, each sequence may include multiple symbols.

The multiple antennas may be denoted as i=1, 2, . . . , I, wherein I is the maximum number of antennas considered;

The multiple sequences may be denoted as s=1, 2, . . . , S, wherein S is the maximum number of sequences considered;

The multiple symbols in each sequence may be sampled as multiple samples, which may be denoted as n=1, 2, . . . , N, wherein N is the maximum number of samples considered.

For example, a PRACH receiver may receive 12 sequences in total, the 12 sequences may be repeated sequences. That is, they are the same at the transmitter side. In order to reduce the complexity of the calculation, for example, the proposed method may only consider 6 sequences. The considered 6 sequences may be also referred as “repetitions”.

In an example, the multiple sequences (i.e., sequences repetitions) used in the calculation may be all of the plurality of repeated sequences (for example all 12 sequences), or a part of the plurality of repeated sequences (for example 6 sequences within the all 12 sequences). If viewing from the perspective of signal, the multiple sequences (i.e., sequences repetitions) used in the calculation may be all or a part of the received preamble signals on the plurality of antennas.

Then, the received sequence may be denoted as y(s, n, i); and the received sequence with a sequence separation may be denoted as y(s−m, n, i)′, wherein the sequence distance (or sequence separation) between the sequence y(s−m, n, i)′ and the sequence y(s, n, i) may be m=1, 2, . . . , S−1. For example, the sequence distance (or sequence separation) between the sequence 10 and sequence 11 is 1.

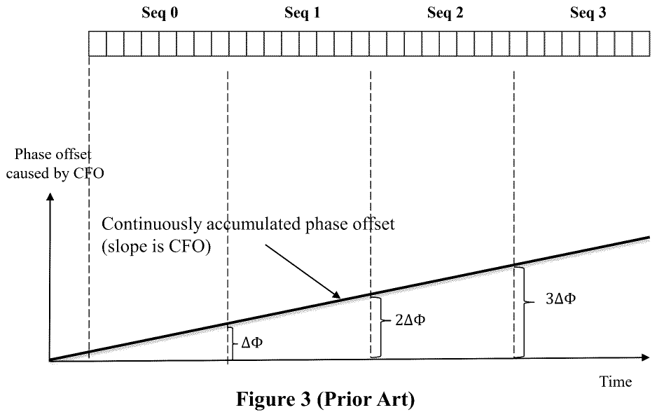

Based on the above denotation, one approach for estimate ΔΦ(m) for a given sequence separation m may be:

$$Δ Φ ( m ) = \frac{1}{m} angle ( {\sum }_{s} {\sum }_{n} {\sum }_{i} y ( s , n , i ) * {y ( s - m , n , i )}^{′} ) \qquad Equation ( 1 )$$

wherein the ΔΦ(m) means the ΔΦ(as shown in FIG. 3) calculated by the sequence separation m, it does not mean that the estimated phase offset of the sequence m. In fact, the estimated phase offset of the sequence s=1, 2, . . . , S should be for example s*ΔΦ.

As shown in the Equation (1), the two sequences, i.e., the sequence y(s−m, n, i)′ and the sequence y(s, n, i) are correlated by using conjugate multiplication. Then, the correlation value is converted into angle to obtain phase offset for sequence separation m. Then, the phase offset for sequence separation m may be divided by m, to obtain the normalized phase offset ΔΦ(m), i.e., phase offset of a single sequence separation (i.e., phase offset between two adjacent sequences).

In an example, performing the phase offset estimation includes calculating a phase of correlation of two repetitions, for a combination including the two repetitions, as shown in the calculation “angle ( )” in equation (1).

If Equation (1) is used for all possible value of m, i.e., for example m=1, 2, . . . . S−1, the final ΔΦ may be:

$$Δ Φ = \frac{1}{S - 1} {\sum }_{m = 1}^{S - 1} \frac{1}{m} angle ( {\sum }_{i = 0}^{I} {\sum }_{s = m}^{S} {\sum }_{n = 0}^{N} y ( s , n , i ) * {y ( s - m , n , i )}^{′} ) \qquad Equation ( 2 )$$

As shown in the Equation (2), for each value of m, for example m=1, 2, . . . . S−1, a combination of two sequences, i.e., the sequence y(s−m, n, i)′ and the sequence y(s, n, i) are correlated by using conjugate multiplication. Then, each of the correlation value is converted into angle to obtain phase offset for sequence separation m. Then, each of the phase offset for sequence separation m may be divided by m, to obtain the normalized phase offset ΔΦ(m), i.e., phase offset of a single sequence separation (i.e., phase offset between two adjacent sequences). Then, the m ΔΦ(m) may be averaged to form the final ΔΦ.

Depending on whether m=1, the two sequences in a combination may be adjacent repetitions or non-adjacent repetitions. For adjacent repetitions, m=1.

Note that, the normalization and average may be seen as a single calculation, i.e., weighted average. That is, in the equation (2), the estimated phase offset is a weighted average of the phase of correlation of the two repetitions relative to a distance (i.e., sequence separation m) of the two repetitions, for all combinations used.

In a specific example of the Equation (2), if there are 12 sequences. All of the possible combinations of any two sequences are used, then there may be

$${C}_{12}^{2} = \frac{12 * 11}{2} = 66$$

combinations of two sequences.

In an example, all of the 66 possible combinations are used for the phase offset estimation in step 421 or only a part of the all 66 possible combinations are used for the phase offset estimation in step 421.

In an example, in order to reduce the complexity, there may be a threshold for the sequence separation m, i.e., combinations each including two repetitions with a sequence separation m (or sequence distance) less than or equal to a threshold are used for the phase offset estimation.

For example, the threshold may be set as 6. As a result, the sequence 1 may be correlated with the sequence 7, but cannot be correlated with sequence 8. Then, only 51 combinations of the all 66 possible combinations are used for the phase offset estimation in step 421.

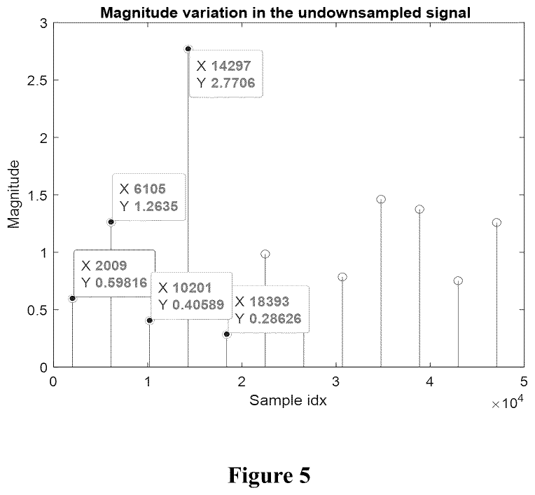

The complexity for using all 66 possible combinations of sequences (or repetitions) are too large. The embodiments may further propose correlating the multiple repetitions based on magnitudes of the elements, so as to reduce the complexity. FIG. 5 shows the magnitude variation in the undownsampled signal. As shown in FIG. 5, there may be magnitude variation in the undownsampled signal, i.e., some of the samples may stronger than other samples. Here, the term “element” may mean the samples on antennas, for example 1024 samples on 4 antennas. The embodiments consider that the stronger samples may cause the samples correlation values, that is the larger correlation may be from the dominant elements.

In an example, the larger correlation value may be considered. For example, top k of the 51 combinations of the all 66 possible combinations, or top k of the all 66 possible combinations may be considered in the phase offset estimation in step 421.

In an example, the top one of the 51 combinations of the all 66 possible combinations, or top one of the all 66 possible combinations may be considered in the phase offset estimation in step 421, i.e., k=1.

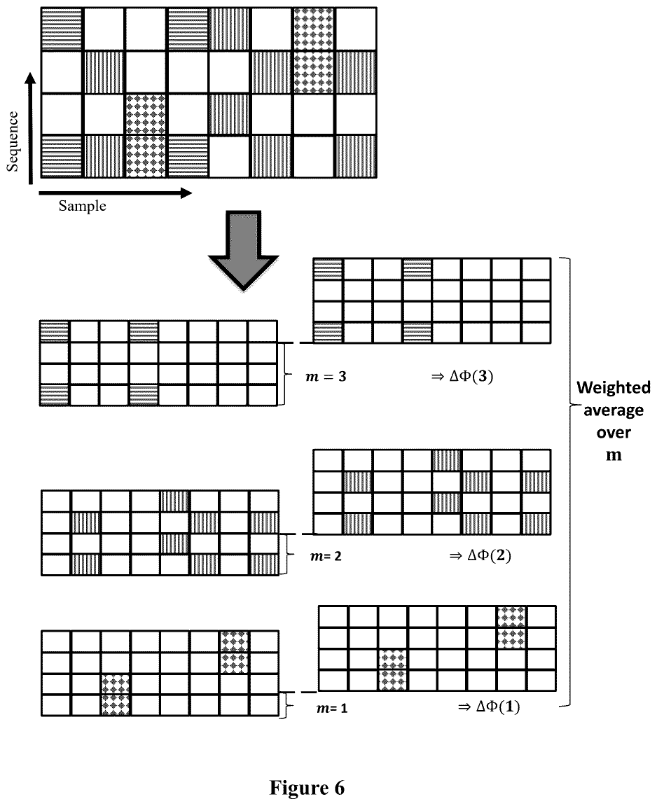

FIG. 6 shows an example phase offset estimation approach, according to the embodiments herein. In the FIG. 6, the antenna dimension is not shown. As shown in the top portion of FIG. 6, the horizontal axis is sample axis and the longitudinal axis is sequence axis. As shown in FIG. 6, there may be 4 sequences (4 repetitions), each sequence may include 8 samples. If there are 4 antennas, then each sequence may include 8*4=32 samples, or be referred as 32 elements; and all 4 sequences include 128 elements.

Note that, the shown sequence length in FIG. 6 is only an example, each sequence may include more or less samples. For example, there may be 1024 samples in one sequence.

Please note that, the shown samples for calculation is an example. For example, a part of samples may be used for calculation. For example, there may be 1024 samples in one sequence, and only 128 of them with larger magnitudes are used for the calculation.

In an example, for each of the 8 elements in a sequence shown in FIG. 6, there may be 4 elements in a column of FIG. 6. For example, for the sample 1 (element 1), which may be referred as “a specific position of the multiple repetitions”, there are 4 elements in the first column.

For this “specific position of the multiple repetitions” (shown as a column in FIG. 6), the dominating elements are selected. For position (n, i), (that is, a specific sample n on a specific antenna i), the dominating elements s1, s2 may be denoted as s1 (n, i), s2 (n, i), (s1<s2) are with two largest abs (y(s,n, i))∇n, i. In an example, the dominating elements may have largest magnitude, i.e., they are dominating elements in terms of magnitude.

Note that, in this example, two dominating elements with the largest magnitudes are used for the correlation, that is the correlation is between one combination including two dominating elements. However, the examples do not limit to this. In another example, three dominating elements with the largest magnitudes are used for the correlation, that is there are three correlations, each of them is between one combination including two of said three dominating elements.

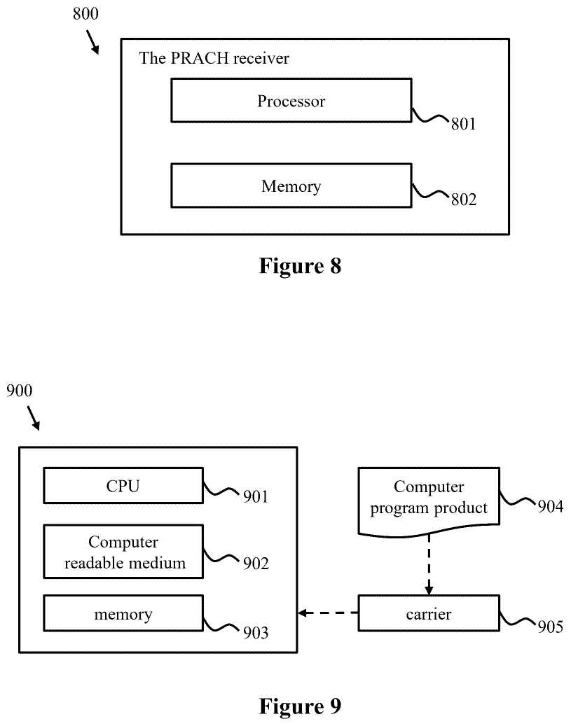

In an example, a plurality of elements located at a specific position of the multiple repetitions respectively are compared, to select two dominating elements in terms of magnitude from the plurality of elements. For example, the dominating elements in position 1 (first column in FIG. 6) may be located in sequence 1 and 4, the dominating elements in position 2 (second column in FIG. 6) may be located in sequence 1 and 3, the dominating elements in position 3 (third column in FIG. 6) may be located in sequence 1 and 2, the dominating elements in position 4 (fourth column in FIG. 6) may be located in sequence 1 and 4, the dominating elements in position 5 (fifth column in FIG. 6) may be located in sequence 2 and 4, the dominating elements in position 6 (sixth column in FIG. 6) may be located in sequence 1 and 3, the dominating elements in position 7 (seventh column in FIG. 6) may be located in sequence 3 and 4, and the dominating elements in position 8 (eighth column in FIG. 8) may be located in sequence 1 and 3.

In an example, two repetitions in which the two dominating elements are located respectively are correlated for the specific position. In order to correlate the dominating elements, in an example, the distance (i.e., sequence separation m) between the dominating elements at each position may be calculated. For example, for position 1-8, m={3, 2, 1, 3, 2, 2, 1, 2}. For each position (n, i), the sequence with same sequence separation m may be correlated.

For example, as shown in bottom portion of FIG. 6, for the positions 1 and 4 with m=3, the sequence 1 may be correlated with sequence 4; for the positions 2, 5, 6 and 8 with m=2, the sequence 1 may be correlated with sequence 3, and the sequence 2 may be correlated with sequence 4; for the positions 3 and 7 with m=1, the sequence 1 may be correlated with sequence 2, the sequence 2 may be correlated with sequence 3, and the sequence 2 may be correlated with sequence 4.

That is, the equation (2) may become the following equation (3), in which the dominating elements are correlated for each position.

$$Δ Φ = \frac{1}{S - 1} {\sum }_{m = 1}^{S - 1} \frac{1}{m} angle ( {\sum }_{( n , i ) ∈ G ( m )} y ( s 2 ( n , i ) , n , i ) * {y ( s 1 ( n , i ) , n , i )}^{′} ) \qquad equation ( 3 )$$

$$where G ( m ) = \{ ( n , i ) with s 2 ( n , i ) - s 1 ( n , i ) == m \} .$$

In the example shown in FIG. 6 and in equation (3), the obtained phase offset from the correlation may be weighted averaged, to obtain the final ΔΦ.

Compared with the equation (1), for the equation (3), for each position within a sequence, the correlation may be done for only one time, as a result, the equation (3) may be seen as only one correlation over the positions. As a result, the complexity of the phase offset estimation may be significantly decreased, especially for a sequence with large number of samples for example 1149 samples. By using the equation (3), the elements that are most influencing and noise resistant may be captured, at the same time, the complexity is reduce.

Note that, some further improvement for equation (1) or equation (2) may be also applicable for equation (3). For example, there may be a threshold the sequence separation m, i.e., combinations each including two repetitions with a sequence separation m (or sequence distance) less than or equal to a threshold are used for the phase offset estimation.

Depending on whether m=1, the two sequences in a combination may be adjacent repetitions or non-adjacent repetitions. For adjacent repetitions, m=1.

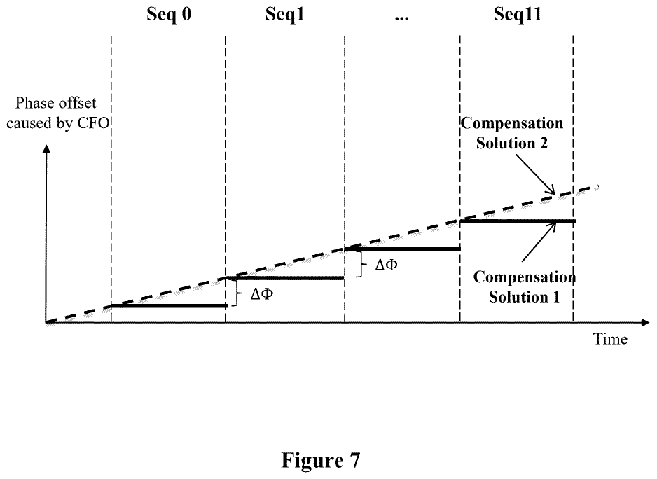

FIG. 7 shows an example phase offset compensation approach, according to the embodiments herein. In the example of FIG. 7, all elements within a repetition are compensated with a constant value based on the estimated phase offset ΔΦ.

For example, as shown in FIG. 7, for the s-th sequence, update y(s, n, i) by:

$${y}^{update} ( s , n , i ) = y ( s , n , i ) * exp ( j * ΔΦ * ( s - 1 ) ) \qquad Equation ( 4 )$$

For example, in an example (Compensation Solution 1 in FIG. 7), sequence 0 is considered as the first sequence, then for all symbols in the following sequence 1, the phase offset compensation is the same, i.e., ΔΦ; for all symbols in the following sequence 2, the phase offset compensation is the same, i.e., 2*ΔΦ, and so on.

In addition, in an alternative approach (Compensation Solution 2 in FIG. 7), the symbols in the same sequence may be compensated with different phase offsets, that is the first symbol is compensated with a phase offset less than the last symbol, so that the phase offset compensation may be linear, as shown in FIG. 7.

In an example, if there are 256 symbols in a sequence, then each symbol may be compensated with a phase offset of ΔΦ/256 more than the previous symbol.

Comparing the two Compensation Solutions in FIG. 7, the Compensation Solution 1 is preferred, since the complexity is low, and the constant part of each sequence influencing performance most. In addition, the Compensation Solution 1 may also work for larger CFO, for example, ΔΦ may be greater than 360 degrees (or 2 π), at this time, the ΔΦ/256 may be wrong, since the estimated ΔΦ may be actually ΔΦ−2 π. That is, although there is no differences for the correlation or sequence combination for ΔΦ and ΔΦ−2 π (they may be seen as the same phase), but the ΔΦ/256 and (ΔΦ−2 π)/256 may be totally different in phase.

Note that, the above proposed features may be combined with each other, to further improve the balance of complexity and detection performance.

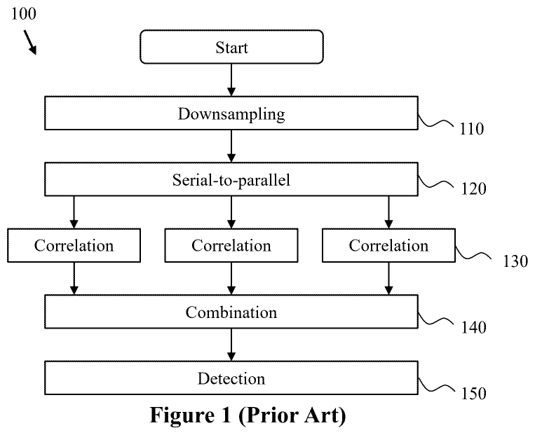

The performances may be compared for the different solutions, prior art solution (1) shown in FIG. 1; prior art solution (2) shown in FIG. 2; the proposed solution (3) by using equation (1) or (2) (making m=1) and (4); the proposed solution (3) by using equation (3) or (4).

The Missed detection rate (MDR) and false alarm rate (FAR) for FR2 B4 60 kHz SCS case from 3GPP standard are compared for the solution (1) to (4), the following table 1 may be obtained.

TABLE 1
Simulated performances of solutions

| | | False alarm rate |
|---|---|---|
| | Missed detection rates | (including extra error) at |
| Solutions | at SNR − 6.9dB | SNR − 6.9dB |
| solution (1) | 0.22% | 5.42% |
| solution (2) | 29.98% | 0.06% |
| solution (3) | 3.14% | 0% |
| solution (4) | 0.3% | 0% |

As may be seen from table 1, the proposed solutions, especially the solution (4) proposed may satisfy the 3GPP requirement on miss detection rate in large CFO and may achieve much better MDR and FAR performances than the prior art solutions.

Complexity of solution (1) of FIG. 1, in which combining is after correlation may be presented in the following tables (in the unit of operations). For short sequence, it is assumed that there are 12 sequence, each with 256 symbols, and for long sequence, it is assumed that there are 4 sequence, each with 1024 symbols.

TABLE 2
Simulated complexity of prior art solution (1) for short sequence

| For short sequence | Per calling | Number of calling | Subtotal |
|---|---|---|---|
| FFT | 256*log2(256) | 2*12 | 49152 |
| Multiplication | 256 | 2*12*64 | 393216 |
| IFFT | 256*log2(256) | 2*12*64 | 3145728 |
| Power | 256 | 2*12*64 | 393216 |
| Combining | 2*12 | 256*64 | 393216 |
| antenna/sequence | | | |
| Total | | | 4374528 |

TABLE 3
Simulated complexity of prior art solution (1) for long sequence

| | | Number of | |
|---|---|---|---|
| For long sequence | Per calling | calling | Subtotal |
| FFT | 1024*log2(1024) | 2*4 | 81920 |
| Multiplication | 1024 | 2*4*64 | 1048576 |
| IFFT | 2048*log2(2048) | 2*4*64 | 11534336 |
| Power | 2048 | 2*4*64 | 1048576 |
| Combining | 2*4 | 2048*64 | 1048576 |
| antenna/sequence | | | |
| Total | | | 14761984 |

Then, for the short sequence and long sequence, the proposed solution (4) may significantly reduce the complexity, for example as shown in the following tables.

TABLE 4
Simulated complexity of proposed solution (4) for short sequence

| | | Number of | |
|---|---|---|---|
| For short sequence | Per calling | calling | Subtotal |
| Find dominating elements | 2*256*11*2 | | 11264 |
| Phase estimation | 2*256*2 + 11*3 | | 1057 |
| Compensation | 256 | 11*2 | 5632 |
| Combining sequence | 12 | 256*2 | 6144 |
| FFT | 256*log2(256) | 2 | 4096 |
| Multiplication | 256 | 2*64 | 32768 |
| IFFT | 256*log2(256) | 2*64 | 262144 |
| Power | 256 | 2*64 | 32768 |
| Combining antenna | 2 | 256*64 | 32768 |
| Total | | | 388641 |

TABLE 5
Simulated complexity of proposed solution (4) for long sequence

| | | Number of | |
|---|---|---|---|
| For long sequence | Per calling | calling | Subtotal |
| Find dominating elements | 2*1024*3*2 | | 12288 |
| Phase estimation | 2*1024*2 + 3*3 | | 4105 |
| Compensation | 1024 | 3*2 | 6144 |
| Combining sequence | 4 | 1024*2 | 8192 |
| FFT | 1024*log2(1024) | 2 | 20480 |
| Multiplication | 2048 | 2*64 | 262144 |
| IFFT | 2048*log2(2048) | 2*64 | 2883584 |
| Power | 2048 | 2*64 | 262144 |
| Combining antenna | 2 | 2048*64 | 262144 |
| Total | | | 3721225 |

By comparing with the solutions (1) and (4) in terms of complexity, the proposed solution (4) may reduce the complexity by 11.26 times for the short sequence and by 3.97 times for the long sequence.

Note that, compared with solutions (2) or (3) (which is substantially same in terms of complexity), the proposed solution may increase the complexity slightly by 6.6% and less than 8.3% for short and long sequences respectively.

FIG. 8 shows an example PRACH receiver 800, according to the embodiments herein. In an embodiment, the example PRACH receiver 800 in FIG. 8 may be configured to perform the above method 400.

In an embodiment, the PRACH receiver 800 may comprise a processor 801; and a memory 802 coupled to the processor 801. The memory 802 may store instructions executable by the processor 801. When the processor 801 executes the instructions, the processor 801 may be configured to perform the above method 400.

Note that, the PRACH receiver 800 may be implemented as hardware, software, firmware and any combination thereof. For example, the PRACH receiver 800 may include a plurality of units, circuities, modules or the like, each of which may be used to perform one or more steps of the example method 400.

In an embodiment, the PRACH receiver 800 may be implemented in a network node of a Radio Access Network (RAN). Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

FIG. 9 shows an example computer-implemented apparatus 900, according to the embodiments herein. In an embodiment, the apparatus 900 may be configured as the above PRACH receiver as shown in FIG. 8.

In an embodiment, the apparatus 900 may include but not limited to at least one processor such as Central Processing Unit (CPU) 901, a computer-readable medium 902, and a memory 903. The memory 903 may comprise a volatile (e.g., Random Access Memory, RAM) and/or non-volatile memory (e.g., a hard disk or flash memory). In an embodiment, the computer-readable medium 902 may be configured to store a computer program and/or instructions, which, when executed by the processor 901, causes the processor 901 to carry out any of the above mentioned methods 400.

In an embodiment, the computer-readable medium 902 (such as non-transitory computer readable medium) may be stored in the memory 903. In another embodiment, the computer program may be stored in a remote location for example computer program product 904 (also may be embodied as computer-readable medium), and accessible by the processor 901 via for example carrier 905.

The computer-readable medium 902 and/or the computer program product 904 may be distributed and/or stored on a removable computer-readable medium, e.g. diskette, CD (Compact Disk), DVD (Digital Video Disk), flash or similar removable memory media (e.g. compact flash, SD (secure digital), memory stick, mini SD card, MMC multimedia card, smart media), HD-DVD (High Definition DVD), or Blu-ray DVD, USB (Universal Serial Bus) based removable memory media, magnetic tape media, optical storage media, magneto-optical media, bubble memory, or distributed as a propagated signal via a network (e.g. Ethernet, ATM, ISDN, PSTN, X.25, Internet, Local Area Network (LAN), or similar networks capable of transporting data packets to the infrastructure node).

The disclosure further proposes the following examples.

Example 1. A method for Physical Random Access Channel (PRACH) preamble detection, comprising:
receiving a PRACH preamble with a plurality of repeated sequences, in which each sequence includes a plurality of elements on a plurality of antennas;
performing a phase offset estimation for multiple repetitions within the plurality of repeated sequences, by selectively correlating the multiple repetitions based on magnitudes of the elements;
performing a phase compensation for the multiple repetitions, based on the estimated phase offset;
performing a sequence combination for the multiple repetitions; and
performing a sequence detection on the combined multiple repetitions.

Example 2. The method according to claim 1,
wherein a plurality of elements located at a specific position of the multiple repetitions respectively are compared, to select two dominating elements in terms of magnitude from the plurality of elements; and
wherein two repetitions in which the two dominating elements are located respectively are correlated for the specific position.

Example 3. The method according to claim 2, wherein the two repetitions are non-adjacent repetitions.

Example 4. The method according to example 1, wherein the multiple repetitions are all or a part of the plurality of repeated sequences, or are all or a part of the received preamble signals on the plurality of antennas.

Example 5. The method according to example 2, wherein all or a part of possible combinations of any two repetitions of the multiple repetitions are used for the phase offset estimation, or combinations each including two repetitions with a distance less than or equal to a threshold are used for the phase offset estimation.

Example 6. The method according to example 5, wherein performing the phase offset estimation includes calculating a phase of correlation of two repetitions, for a combinations including the two repetitions.

Example 7. The method according to example 6, wherein the estimated phase offset is a weighted average of the phase of correlation of the two repetitions relative to a distance of the two repetitions, for all combinations used.

Example 8. The method according to example 1, wherein all possible combinations of any two repetitions of the multiple repetitions are correlated for a specific position of the multiple repetitions, to select k combinations with top k correlation values;
wherein the k correlation values are used for the phase offset estimation.

Example 9. The method according to example 1, wherein in the phase compensation, all elements within a repetition are compensated with a constant value based on the estimated phase offset.

Example 10. The method according to example 1, wherein the method is implemented on a Non-Terrestrial Network (NTN) PRACH receiver; and
wherein the method further comprising:
   performing a pre-compensation for the multiple repetitions based on satellite orbit information, before performing the phase offset estimation.

Example 11. A PRACH receiver in a wireless communication system, the PRACH receiver comprising:
a memory storing machine-readable instructions; and
a processor for executing the machine-readable instructions such that, when the processor executes the machine-readable instructions, it configures the PRACH receiver to:
   receive a PRACH preamble with a plurality of repeated sequences, in which each sequence includes a plurality of elements on a plurality of antennas;
   perform a phase offset estimation for multiple repetitions within the plurality of repeated sequences, by selectively correlating the multiple repetitions based on magnitudes of the elements;
   perform a phase compensation for the multiple repetitions, based on the estimated phase offset;
   perform a sequence combination for the multiple repetitions; and
   perform a sequence detection on the combined multiple repetitions.

Example 12. The PRACH receiver according to example 11,
wherein a plurality of elements located at a specific position of the multiple repetitions respectively are compared, to select two dominating elements in terms of magnitude from the plurality of elements; and
wherein two repetitions in which the two dominating elements are located respectively are correlated for the specific position.

Example 13. The PRACH receiver according to example 12, wherein the two repetitions are non-adjacent repetitions.

Example 14. The PRACH receiver according to example 11, wherein the multiple repetitions are all or a part of the plurality of repeated sequences, or are all or a part of the received preamble signals on the plurality of antennas.

Example 15. The PRACH receiver according to example 12, wherein all or a part of possible combinations of any two repetitions of the multiple repetitions are used for the phase offset estimation, or combinations each including two repetitions with a distance less than or equal to a threshold are used for the phase offset estimation.

Example 16. The PRACH receiver according to example 15, wherein performing the phase offset estimation includes calculating a phase of correlation of two repetitions, for a combinations including the two repetitions.

Example 17. The PRACH receiver according to example 16, wherein the estimated phase offset is a weighted average of the phase of correlation of the two repetitions relative to a distance of the two repetitions, for all combinations used.

Example 18. The PRACH receiver according to example 11, wherein all possible combinations of any two repetitions of the multiple repetitions are correlated for a specific position of the multiple repetitions, to select k combinations with top k correlation values;
wherein the k correlation values are used for the phase offset estimation.

Example 19. The PRACH receiver according to example 11, wherein in the phase compensation, all elements within a repetition are compensated with a constant value based on the estimated phase offset.

Example 20. A computer readable product comprising computer readable code, which when run on an apparatus, causes the apparatus to perform any one of the above methods.

It will be recognized that principles of the disclosure are not limited to the embodiments so described, but instead can be practiced with modification and alteration without departing from the scope of the appended claims. The above embodiments may include the undertaking only a subset of such features, undertaking a different order of such features, undertaking a different combination of such features, and/or undertaking additional features than those features explicitly listed. The scope of the embodiments should, therefore, be determined with reference to the appended claims, along with the full scope of equivalents to which such claims are entitled.

What is claimed is:

1. A method for Physical Random Access Channel (PRACH) preamble detection, comprising:
receiving a PRACH preamble with a plurality of repeated sequences, in which each sequence includes a plurality of elements on a plurality of antennas;
performing a phase offset estimation for multiple repetitions within the plurality of repeated sequences, by selectively correlating the multiple repetitions based on magnitudes of the elements;
performing a phase compensation for the multiple repetitions, based on the estimated phase offset;
performing a sequence combination for the multiple repetitions; and
performing a sequence detection on the combined multiple repetitions.

2. The method according to claim 1,
wherein a plurality of elements located at a specific position of the multiple repetitions respectively are compared, to select two dominating elements in terms of magnitude from the plurality of elements; and
wherein two repetitions in which the two dominating elements are located respectively are correlated for the specific position.

3. The method according to claim 2, wherein the two repetitions are non-adjacent repetitions.

4. The method according to claim 1, wherein the multiple repetitions are all or a part of the plurality of repeated sequences, or are all or a part of the received preamble signals on the plurality of antennas.

5. The method according to claim 2, wherein all or a part of possible combinations of any two repetitions of the multiple repetitions are used for the phase offset estimation, or combinations each including two repetitions with a distance less than or equal to a threshold are used for the phase offset estimation.

6. The method according to claim 5, wherein performing the phase offset estimation includes calculating a phase of correlation of two repetitions, for a combinations including the two repetitions.

7. The method according to claim 6, wherein the estimated phase offset is a weighted average of the phase of correlation of the two repetitions relative to a distance of the two repetitions, for all combinations used.

8. The method according to claim 1, wherein all possible combinations of any two repetitions of the multiple repetitions are correlated for a specific position of the multiple repetitions, to select k combinations with top k correlation values;
wherein the k correlation values are used for the phase offset estimation.

9. The method according to claim 1, wherein in the phase compensation, all elements within a repetition are compensated with a constant value based on the estimated phase offset.

10. The method according to claim 1, wherein the method is implemented on a Non-Terrestrial Network (NTN) PRACH receiver; and
wherein the method further comprising:
performing a pre-compensation for the multiple repetitions based on satellite orbit information, before performing the phase offset estimation.

11. A PRACH receiver in a wireless communication system, the PRACH receiver comprising:
a memory storing machine-readable instructions; and
a processor for executing the machine-readable instructions such that, when the processor executes the machine-readable instructions, it configures the PRACH receiver to:
receive a PRACH preamble with a plurality of repeated sequences, in which each sequence includes a plurality of elements on a plurality of antennas;
perform a phase offset estimation for multiple repetitions within the plurality of repeated sequences, by selectively correlating the multiple repetitions based on magnitudes of the elements;
perform a phase compensation for the multiple repetitions, based on the estimated phase offset;
perform a sequence combination for the multiple repetitions; and
perform a sequence detection on the combined multiple repetitions.

12. The PRACH receiver according to claim 11,
wherein a plurality of elements located at a specific position of the multiple repetitions respectively are compared, to select two dominating elements in terms of magnitude from the plurality of elements; and
wherein two repetitions in which the two dominating elements are located respectively are correlated for the specific position.

13. The PRACH receiver according to claim 12, wherein the two repetitions are non-adjacent repetitions.

14. The PRACH receiver according to claim 11, wherein the multiple repetitions are all or a part of the plurality of repeated sequences, or are all or a part of the received preamble signals on the plurality of antennas.

15. The PRACH receiver according to claim 12, wherein all or a part of possible combinations of any two repetitions of the multiple repetitions are used for the phase offset estimation, or combinations each including two repetitions with a distance less than or equal to a threshold are used for the phase offset estimation.

16. The PRACH receiver according to claim 15, wherein performing the phase offset estimation includes calculating a phase of correlation of two repetitions, for a combinations including the two repetitions.

17. The PRACH receiver according to claim 16, wherein the estimated phase offset is a weighted average of the phase of correlation of the two repetitions relative to a distance of the two repetitions, for all combinations used.

18. The PRACH receiver according to claim 11, wherein all possible combinations of any two repetitions of the multiple repetitions are correlated for a specific position of the multiple repetitions, to select k combinations with top k correlation values;
wherein the k correlation values are used for the phase offset estimation.

19. The PRACH receiver according to claim 11, wherein in the phase compensation, all elements within a repetition are compensated with a constant value based on the estimated phase offset.

20. A computer readable product comprising computer readable code, which when run on an apparatus, causes the apparatus to:
receive a PRACH preamble with a plurality of repeated sequences, in which each sequence includes a plurality of elements on a plurality of antennas;
perform a phase offset estimation for multiple repetitions within the plurality of repeated sequences, by selectively correlating the multiple repetitions based on magnitudes of the elements;
perform a phase compensation for the multiple repetitions, based on the estimated phase offset;
perform a sequence combination for the multiple repetitions; and
perform a sequence detection on the combined multiple repetitions.
